(19) United States
(12) Patent Application Publication
(10) Pub. No.: US 2004/0021767 A1
(43) Pub. Date: Feb. 5, 2004

(54) Image sensing apparatus and control method thereof

(75) Inventors: Takaaki Endo, Chiba (JP); Akihiro Katayama, Kanagawa (JP); Masahiro Suzuki, Kanagawa (JP); Daisuke Kotake, Kanagawa (JP); Yukio Sakagawa, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/630,804

(22) Filed: Jul. 31, 2003

(30) Foreign Application Priority Data
Aug. 5, 2002 (JP) 2002-228025

(51) Int. Cl. H04N 13/00; H04N 7/00

(52) U.S. Cl. 348/42; 348/36

(57) ABSTRACT

An apparatus includes a camera (201) for sensing a first direction, a camera (202) for sensing a second direction, a mirror (221) for controlling the view of the camera (201) to a first view, and a mirror (222) for controlling the view of the camera (202) to a second view. The mirrors (221, 222) do not share ridge lines with each other, and the lens center of a virtual camera having the first view approximately matches that of a virtual camera having the second view.

### FIELD OF THE INVENTION

The present invention relates to an image sensing apparatus for sensing a broad view range, and a control method thereof.

### BACKGROUND OF THE INVENTION

An attempt has been made to sense a real space by an image sensing apparatus mounted on a mobile, and expressing the sensed real space as a virtual space using a computer on the basis of the sensed photo-realistic image data (see, e.g., Endo, Katayama, Tamura, Hirose, Watanabe, & Tanikawa: “Method of Generating Image-Based Cybercities By Using Vehicle-Mounted Cameras” (IEICE Society, PA-3-4, pp. 276-277, 1997), or Hirose, Watanabe, Tanikawa, Endo, Katayama, & Tamura: “Building Image-Based Cybercities By Using Vehicle-Mounted Cameras (2)-Generation of Wide-Range Virtual Environment by Using Photo-realistic Images-” (Proc. of the Virtual Reality Society of Japan, Vol.2, pp.67-70, 1997), and the like).

As a method of expressing a sensed real space as a virtual space on the basis of photo-realistic image data sensed by an image sensing apparatus mounted on a mobile, a method of reconstructing a geometric model of the real space on the basis of the photo-realistic image data, and expressing the virtual space using a conventional CG technique is known. However, this method has limits in terms of the accuracy, exactitude, and reality of the model. On the other hand, an Image-Based Rendering (IBR) technique that expresses a virtual space using a photo-realistic image without any reconstruction using a model has attracted attention. The IBR technique generates an image viewed from an arbitrary viewpoint on the basis of a plurality of photo-realistic images. Since the IBR technique is based on photo-realistic images, it can express a realistic virtual space.

In order to build a virtual space that allows walkthrough using such IBR technique, an image must be generated and presented in correspondence with the user's position in the virtual space. For this reason, in such system, respective frames of photo-realistic image data and positions in the virtual space are saved in correspondence with each other, and a corresponding frame is acquired and reproduced on the basis of the user's position and visual axis direction in the virtual space.

As a method of acquiring position data in a real space, a positioning system using an artificial satellite such as GPS (Global Positioning System) used in a car navigation system or the like is generally used. As a method of determining correspondence between position data obtained from the GPS or the like and photo-realistic image data, a method of determining the correspondence using a time code has been proposed (Japanese Patent Laid-Open No. 11-168754, U.S. Pat. No. 6,335,754). With this method, the correspondence between respective frame data of photo-realistic image data and position data is determined by determining the correspondence between time data contained in position data, and time codes appended to the respective frame data of photo-realistic image data.

The walkthrough process in such virtual space allows the user to view a desired direction at each viewpoint position. For this purpose, images at respective viewpoint positions may be saved as a panoramic photo-realistic image that can cover a broader range than the field angle upon reproduction, and a partial image to be reproduced may be extracted from the panoramic photo-realistic image on the basis of the user's viewpoint position and visual axis direction in the virtual space, and the extracted partial image may be displayed.

As a data format of a panoramic photo-realistic image, broad view (perimeter) images at an identical time from one viewpoint are preferably used. In order to sense such images, an apparatus senses the views of a plurality of cameras reflected by a pyramid mirror. FIG. 1 shows this example.

As shown in FIG. 1, a pyramid mirror 11 is made up of plane mirrors as many as cameras in a camera unit 12. Each plane mirror shares ridge lines of the pyramid with neighboring plane mirrors. Each of the cameras which form the camera unit 12 senses a surrounding visual scene reflected by the corresponding plane mirror. If the cameras are laid out so that the virtual images of the lens centers of the respective cameras formed by the plane mirrors match, images can be sensed at an identical time from one viewpoint. Note that the respective mirrors maintain an angle of 45° with a vertical line 15 in the vertical direction in FIG. 1.

However, with the aforementioned image sensing apparatus, when the total diameter of the apparatus is to be reduced, a plurality of cameras physically interfere with each other, and there is a limit to a size reduction attainable.

The present invention has been made in consideration of the aforementioned problems, and has as its object to sense a broad view range from one viewpoint at an identical time and a high resolution using an image sensing apparatus having a small total diameter.

### SUMMARY OF THE INVENTION

In order to achieve the above object, for example, an image sensing apparatus of the present invention comprises the following arrangement.

That is, an image sensing apparatus comprises:

first image sensing unit adapted to sense a first direction;

second image sensing unit adapted to sense a second direction;

first view control unit adapted to control a view of the first image sensing unit to a first view different from that view; and

second view control unit adapted to control a view of the second image sensing unit to a second view adjacent to the first view in a horizontal plane,

wherein the first and second view control units do not share ridge lines with each other, and a lens center of virtual image sensing unit having the first view approximately matches a lens center of virtual image sensing unit having the second view.

In order to achieve the above object, for example, a method of the present invention comprises the following arrangement.

That is, a method of controlling an image sensing apparatus comprises:

a step of sensing a first direction using first image sensing unit;

a step of sensing a second direction using second image sensing unit;

a step of controlling a view of the first image sensing unit to a first view different from that view using first view control means; and

a step of controlling a view of the second image sensing unit to a second view adjacent to the first view in a horizontal plane using second view control means,

wherein the first and second view control units do not share ridge lines with each other, and a lens center of virtual image sensing unit having the first view approximately matches a lens center of virtual image sensing unit having the second view.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing a conventional arrangement that senses a broad view by reflecting the views of a plurality of cameras by a pyramid mirror;

FIG. 2A is a view for explaining the arrangement of an image sensing apparatus, which comprises two cameras 201 and 202 and two mirrors 221 and 222, according to the first embodiment of the present invention;

FIG. 2B is a view showing the image sensing apparatus shown in FIG. 2A viewed from above in the vertical direction;

FIG. 3 shows the relationship of respective parts between a top view and side view of an image sensing apparatus, which comprises six cameras and six mirrors, according to the first embodiment of the present invention;

FIG. 4 is a view showing the arrangement of an image sensing apparatus, which is used to sense images at an identical time from one viewpoint, according to the first embodiment of the present invention;

FIG. 5 is a flow chart of a process for sensing images of a broad field angle at an identical time from one view point according to the first embodiment of the present invention;

FIG. 6 is a flow chart of a process for joining the sensed images according to the first embodiment of the present invention;

FIG. 7A is a view for explaining the arrangement of an image sensing apparatus, which comprises two cameras 701 and 702 and two mirrors 721 and 722, according to the second embodiment of the present invention;

FIG. 7B is a view showing the image sensing apparatus shown in FIG. 7A viewed from above in the vertical direction;

FIG. 8 shows the relationship of respective parts between a top view and side view of an image sensing apparatus, which comprises six cameras and six mirrors, according to the second embodiment of the present invention;

FIG. 9 is a top view of the image sensing apparatus according to the third embodiment of the present invention;

FIG. 10 is a view for explaining a margin portion in the fourth embodiment of the present invention;

FIG. 11 is a view showing the arrangement of cameras whose lens centers are virtually matched using prisms, and the prisms, according to the fifth embodiment of the present invention; and

FIG. 12 is a view showing the arrangement of cameras whose lens centers are virtually matched using large lenses, and the large lenses, according to the fifth embodiment of the present invention.

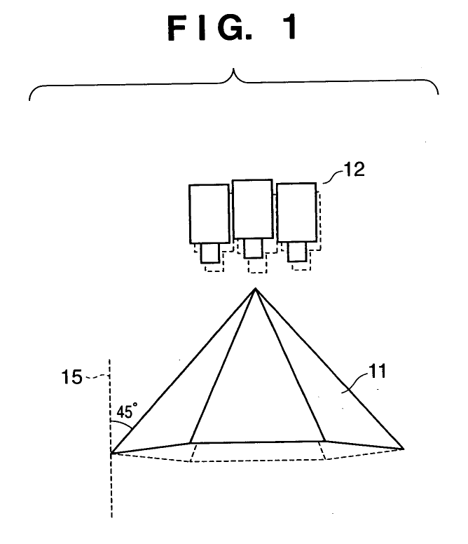

### DETAILED DESCRIPTION OF THE PREFERRED EMBODIMENTS

Preferred embodiments of the present invention will now be described in detail in accordance with the accompanying drawings.

[First Embodiment]

This embodiment will explain an image sensing apparatus which has a small total diameter (small apparatus scale) and senses a broad view range at an identical time and a high resolution from one viewpoint, and a control method thereof.

For the sake of simplicity, an image sensing apparatus which comprises two cameras, and two mirrors used to reflection-control the views of the cameras will be exemplified below.

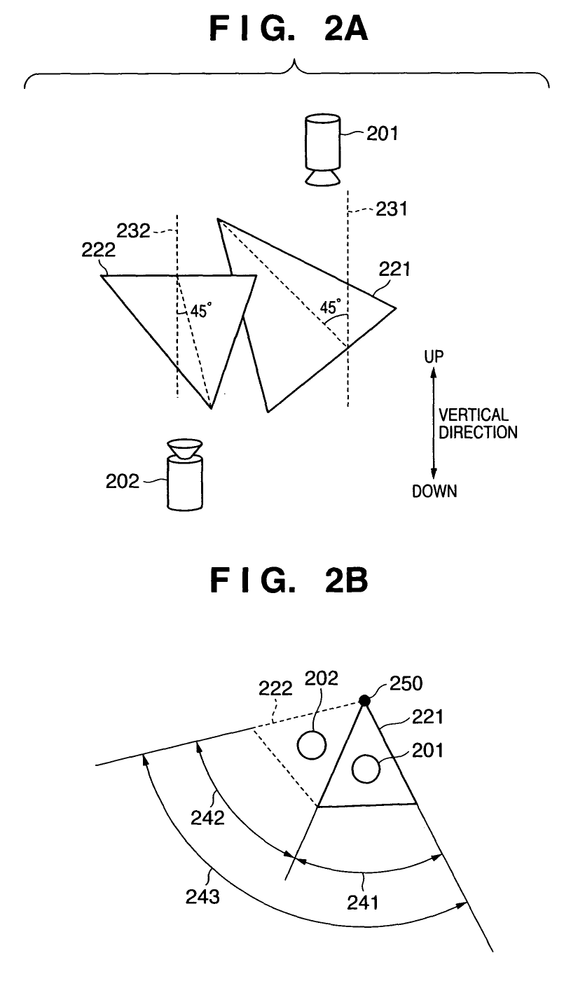

FIG. 2A is a view for explaining the arrangement of an image sensing apparatus which comprises two cameras 201 and 202, and two mirrors 221 and 222. The camera 201 is fixed so that its visual axis direction agrees with the vertically downward direction in FIG. 2A, and the camera 202 is fixed so that visual axis direction agrees with the vertically upward direction in FIG. 2A. The distance (first distance) between the camera 201 and mirror 221 in the vertical direction in FIG. 2A, and that (second distance) between the camera 202 and mirror 222 are equal to each other, and they maintain a distance to be described later.

The mirrors 221 and 222 have an identical shape, are arranged not to share a ridge line, and maintain an angle of 450 with lines 231 and 232 in the vertical direction in FIG. 2A. The incident angle of a visual axis direction vector of the camera 201 to the mirror 221, and that of the visual axis direction vector of the camera 202 to the mirror 222 are respectively 45°. In this embodiment, the mirrors 221 and 222 are alternately arranged not to share a ridge line.

FIG. 2B shows the image sensing apparatus shown in FIG. 2A viewed from above in the vertical direction of FIG. 2A. A portion indicated by the dotted lines in FIG. 2B indicates the reverse side (non-reflection surface). The view of the camera 201 is reflected by the mirror 221 to form a view 241. On the other hand, the view of the camera 202 is reflected by the mirror 222 to form a view 242. Since the first and second distances are equal to each other, the field angles of the views 241 and 242 are also equal to each other. Hence, by adjusting both the first and second distances to a predetermined distance, the views 241 and 242 neighbor on a horizontal plane (a plane having the vertical direction as a normal direction), and the cameras 201 and 202 can cover a view 243 (view 241+view 242).

Since the field angles of the views 241 and 242 are equal to each other, the lens central position of a virtual camera having the view 241 approximately matches that of a virtual camera having the view 242, and this lens central position becomes a lens central position 250 of a virtual camera having the view 243. That is, the cameras 201 and 202 can realize a single virtual camera having the view 243.

As described above, the views of the two cameras which are arranged in directions different through 180° are reflected by the two mirrors, and the lens centers of the two virtual cameras having the reflected views are matched, thereby broadening the view that can be covered by the overall camera, and sensing an image in a broader view. In addition, according to the above arrangement, since the two cameras are arranged at largely separate positions and do not physically interfere with each other, the total diameter of the image sensing apparatus can be reduced.

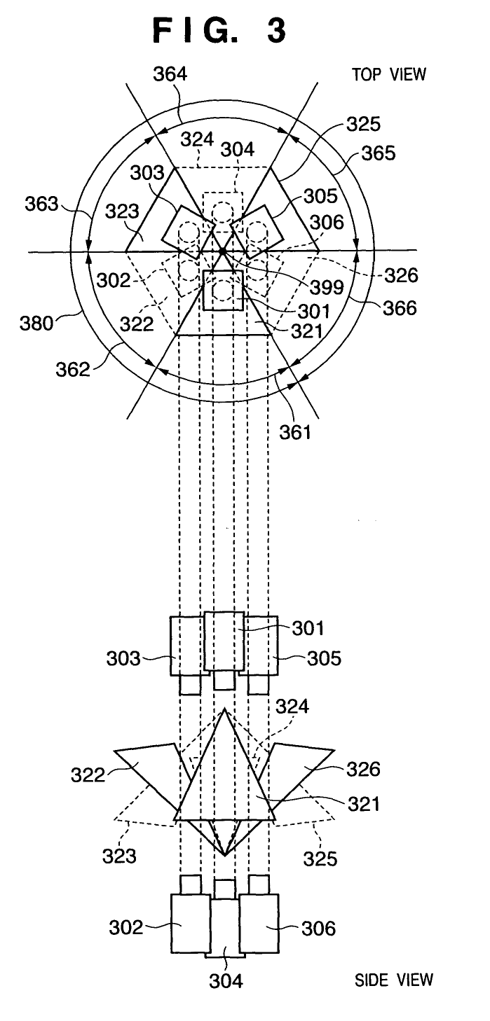

An image sensing apparatus which uses six cameras and six mirrors so as to obtain a broader view range using the same mechanism will be explained below. FIG. 3 shows the relationship of respective parts between a top view and side view of an image sensing apparatus which comprises six cameras and six mirrors.

Referring to FIG. 3, the view of a camera 301 is reflected by a mirror 321 to form a view 361 according to the principle described using FIG. 2. Likewise, the views of cameras 302 to 306 are reflected by mirrors 322 to 326 to form views 362 to 366, respectively. Since two each of cameras and mirrors have the arrangement that has been explained using FIG. 2, the lens central positions of virtual cameras having the views 361 to 366 approximately match at a point 399. As a result, the cameras 301 to 306 can cover a view 380 (view 361+view 362+view 363+view 364+view 365+view 366). That is, a visual scene within the range of this view 380, i.e., in the perimeter direction can be sensed.

With the above arrangement, the view with a larger field angle than that obtained by the arrangement shown in FIG. 2 can be obtained, and an image within this view can be sensed. With the above arrangement, since the cameras are alternately arranged at largely separate positions and do not physically interfere with each other, the total diameter of the image sensing apparatus can be reduced.

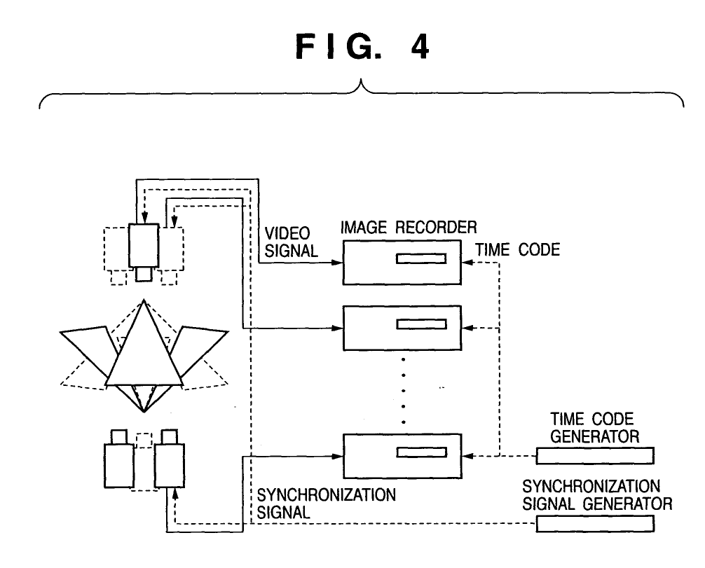

FIG. 4 shows the arrangement of the aforementioned image sensing apparatus used to sense images at an identical time from one viewpoint in this embodiment.

Image recorders are connected to respective cameras. An image sensed by each camera is sent to and stored in an image recorder connected to that camera. Note that each camera senses a moving image, and sends still images for respective frames to the image recorder, which sequentially record received images for respective frames.

A synchronization signal generator is connected to the respective cameras. In order to control the respective cameras to sense images at an identical time and to control the respective image recorders to record the images sensed at an identical time, the respective cameras must sense images synchronously. Hence, the synchronization signal generator sends a synchronization signal to the respective cameras. This synchronization signal is used to, e.g., synchronize shutter timings. With this signal, the respective cameras can sense images synchronously.

A time code generator is connected to the respective image recorders. The time code generator appends times (image sensing times) counted by itself to images sequentially recorded in each image recorder as data. In this manner, by appending the image sensing time to each sensed image, an image group sensed at a desired time among images stored in the image recorders can be specified. Using this image group, an image having a broad field angle at a desired time can be obtained. Note that data to be appended to each image is not limited to the image sensing time. For example, position data acquired by, e.g., a GPS or the like may be appended in place of the image sensing time. Also, indices 1, 2, 3, 4, . . . may be assigned to images in turn in the order that they are recorded in each image recorder. That is, images sensed at an identical time need only be specified from image groups held by the respective image recorders.

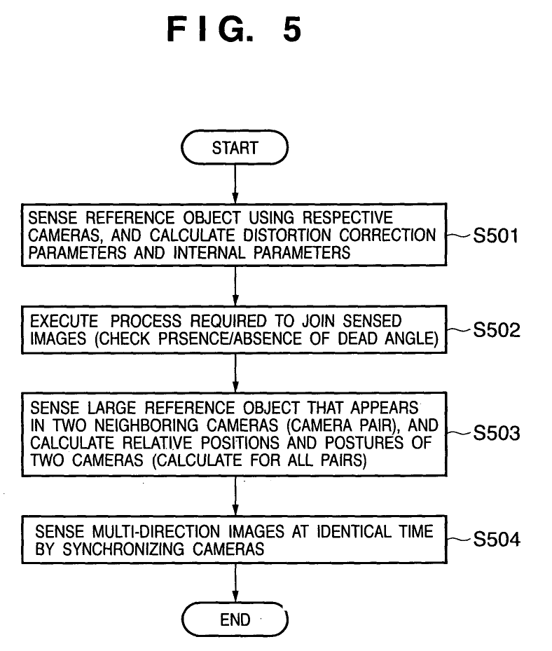

The process for sensing images of a broad field angle at an identical time from one viewpoint using the image sensing apparatus with the above arrangement will be described below using the flow chart of FIG. 5 which shows that process.

In step S501, the respective cameras sense images of a reference object, and distortion correction parameters and internal parameters (focal length and the like) of the cameras are calculated (adjusted) so that the reference object can be accurately sensed (the reference object falls within the view of each camera, the object is visually in focus, and so forth). As for the cameras which cannot directly sense images of the reference object, i.e., can sense images of the reference object by reflecting their views by the mirrors, images of the reference object are sensed using the mirrors, and the aforementioned parameters are calculated (adjusted). The process for calculating (adjusting) the parameters may be done by the cameras automatically or manually.

In step S502, a process for joining images sensed by the respective cameras (to be described later) is executed. More specifically, when an object extends across the views of neighboring cameras, the positions/postures of the cameras are corrected, so that the respective cameras can sense images of such object without any dead angle.

In step S503, a large reference object which appears in both two neighboring cameras is sensed, and the relative positions and postures of these cameras are calculated. This process is required to join images sensed by the respective cameras, as will be described in detail later. This process is repeated for all pairs of cameras.

Finally, the respective cameras synchronously sense images at an identical time in step S504. Image sensing time data is appended to each sensed image as a time code, as described above.

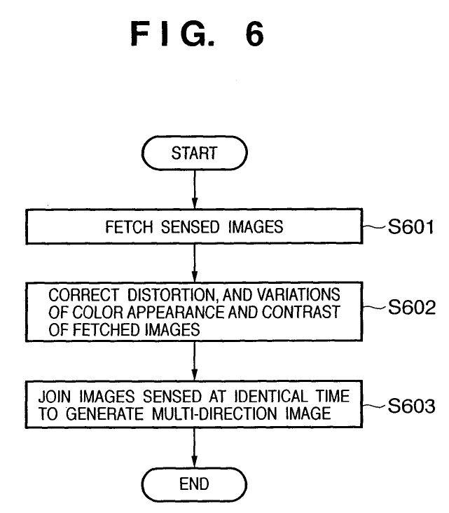

With the above process, images of a broad field angle at an identical time from one viewpoint can be generated. The process for joining the sensed images will be described below using the flow chart of FIG. 6 which shows that process.

In step S601, the sensed images are fetched. More specifically, a computer such as a general personal computer (PC) or the like fetches the images from the image recorders shown in FIG. 4. When a PC is used as the image recorder, the process in this step is replaced by a process for loading the sensed images, which are saved in, e.g., an external storage device such as a hard disk or the like, onto a memory such as a RAM or the like. Hence, subsequent processes are done by the PC.

In step S602, variations of distortion, color appearance, contrast, and the like of the fetched images are corrected. More specifically, for example, a process for changing the pixel values of a portion that neighbors another image so that the color appearance and contrast between neighboring images change smoothly is performed. Note that this process is normally executed using image processing software.

Finally, in step S603, images sensed at an identical time are joined in accordance with the positions and postures of the cameras, which are calculated in step S503, with reference to the time codes appended to the images. More specifically, the order of images to be joined, overlaps between neighboring images, and the like are determined in accordance with the positions and postures of the cameras.

As described above, according to the image sensing apparatus and control method thereof in this embodiment, a broad view at an identical time from one viewpoint can be obtained. As a result, images within the view range can be sensed.

Since the cameras are alternately arranged at largely separate positions and do not physically interfere with each other, the total diameter of the image sensing apparatus can be reduced. Since images are sensed using a plurality of cameras, an image with a higher resolution than that taken by a single camera can be obtained.

In this embodiment, a visual scene in the perimeter direction is sensed using the six cameras. However, the present invention is not limited to this, and an arbitrary number of cameras may be used. In this embodiment, each camera senses a moving image. However, the present invention is not limited to this, and each camera may sense a still image.

[Second Embodiment]

This embodiment will explain another example of an image sensing apparatus which senses a broad view range from one viewpoint at a high resolution and has a small total diameter.

For the sake of simplicity, an image sensing apparatus which comprises two cameras, and two mirrors used to reflection-control the views of the cameras will be exemplified below.

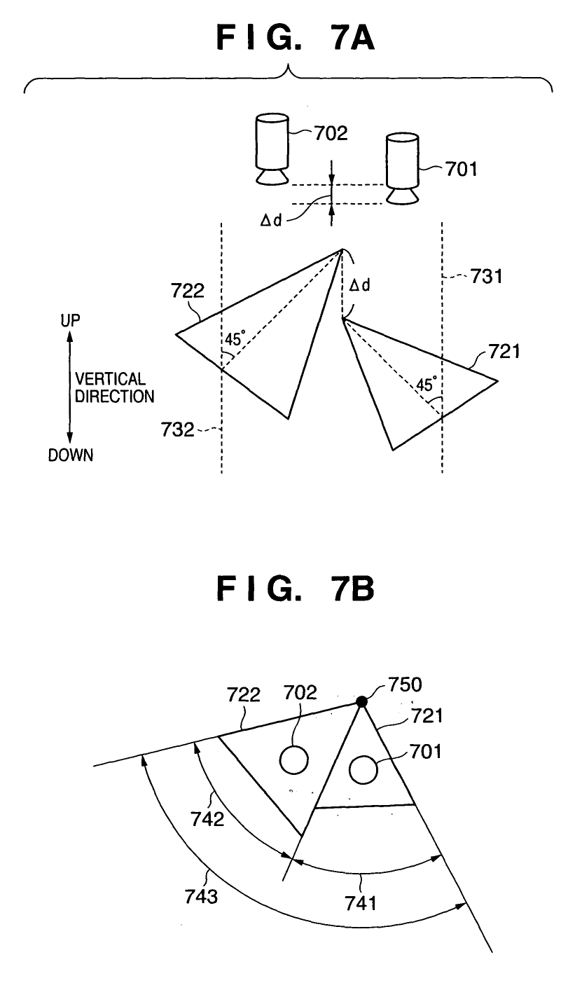

FIG. 7A is a view for explaining the arrangement of an image sensing apparatus which comprises two cameras 701 and 702, and two mirrors 721 and 722. The cameras 701 and 702 are fixed so that their visual axis directions agree with the vertically downward direction in FIG. 7A. The distance (first distance) between the camera 701 and mirror 721 in the vertical direction is Ad shorter than that (second distance) between the camera 702 and mirror 722 in the vertical direction.

The mirrors 721 and 722 have an identical shape, and are arranged not to share a ridge line. The mirror 722 is set at a position shifted by Δd vertically upward in FIG. 7A from the mirror 721. The mirrors 721 and 722 maintain an angle of 450 with lines 731 and 732 in the vertical direction in FIG. 7A. That is, an incident angle of a visual axis direction vector of the camera 701 to the mirror 721, and that of a visual axis direction vector of the camera 702 to the mirror 722 are respectively 45°.

FIG. 7B shows the image sensing apparatus shown in FIG. 7A viewed from above in the vertical direction of FIG. 7A. The view of the camera 701 is reflected by the mirror 721 to form a view 741. On the other hand, the view of the camera 702 is reflected by the mirror 722 to form a view 742. The field angles of the views 741 and 742 are equal to each other. Since the first distance is Ad shorter than the second distance, the views 741 and 742 neighbor on a horizontal plane (a plane having the vertical direction as a normal direction), and the cameras 701 and 702 can cover a view 743 (view 741+view 742).

Since the field angles of the views 741 and 742 are equal to each other, the lens central position of a virtual camera having the view 741 approximately matches that of a virtual camera having the view 742, and this lens central position becomes a lens central position 750 of a virtual camera having the view 743. That is, the cameras 701 and 702 can form a single virtual camera having the view 743.

As described above, the views of the two cameras which are arranged in the same direction are reflected by the two mirrors whose positions are slightly shifted, and the lens centers of the two virtual cameras having the reflected views are matched, thereby broadening the view that can be covered by the overall camera, and sensing an image in a broader view. With this method, since the two cameras are arranged at slightly separate positions and do not physically interfere with each other, the total diameter of the image sensing apparatus can be reduced.

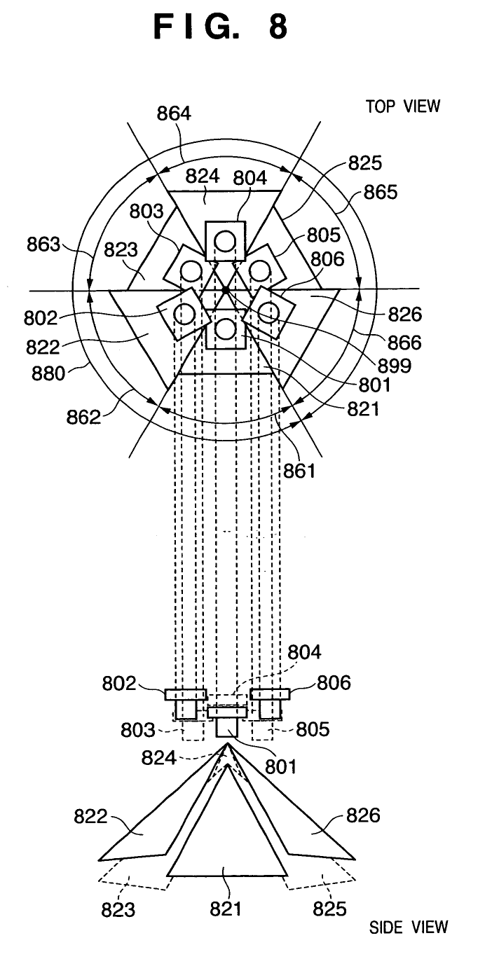

An image sensing apparatus which uses six cameras and six mirrors so as to obtain a broader view range using the same mechanism will be explained below. FIG. 8 shows the relationship of respective parts between a top view and side view of an image sensing apparatus which comprises six cameras and six mirrors.

The layout of two each of cameras and mirrors shown in FIG. 8 is based on that shown in FIG. 7. Referring to FIG. 8, reference numerals 801 to 806 denote cameras; and 821 to 826, mirrors. Note that the mirrors 821 to 826 do not share ridge lines with each other. An upper drawing in FIG. 8 is the top view of the image sensing apparatus, and a lower drawing in FIG. 8 is the side view of the image sensing apparatus.

In FIG. 8, the view of a camera 801 is reflected by a mirror 821 to form a view 861. Likewise, the views of cameras 802 to 806 are reflected by mirrors 822 to 826 to form views 862 to 866, respectively. The lens central positions of virtual cameras having the views 861 to 866 approximately match at a point 899. As a result, the cameras 801 to 806 can cover a view 880 (view 861+view 862+view 863+view 864+view 865+view 866). That is, a visual scene within the range of this view 880, i.e., in the perimeter direction can be sensed.

With the above arrangement, the view with a larger field angle than that obtained by the arrangement shown in FIG. 7 can be obtained, and an image within this view can be sensed. With the above arrangement, since the cameras are alternately arranged at slightly separate positions (separated by Δd) and do not physically interfere with each other, the total diameter of the image sensing apparatus can be reduced.

The arrangement of the image sensing apparatus of this embodiment, which is used to sense images at an identical time from one viewpoint is the same as that in FIG. 4. A flow chart of a process for sensing images of a broad field angle at an identical time from one viewpoint is the same as that in FIG. 5. Also, a flow chart of a process for joining the sensed image is the same as that in FIG. 6.

As described above, according to the image sensing apparatus and control method thereof in this embodiment, a broad view at an identical time from one viewpoint can be obtained. As a result, images within the view range can be sensed. Since the cameras are alternately arranged at slightly separate positions and do not physically interfere with each other, the total diameter of the image sensing apparatus can be reduced.

Since images are sensed using a plurality of cameras, an image with a higher resolution than that taken by a single camera can be obtained. In this embodiment, a visual scene in the perimeter direction is sensed using the six cameras. However, the present invention is not limited to this, and an arbitrary number of cameras may be used. In this embodiment, each camera senses a moving image. However, the present invention is not limited to this, and each camera may sense a still image.

[Third Embodiment]

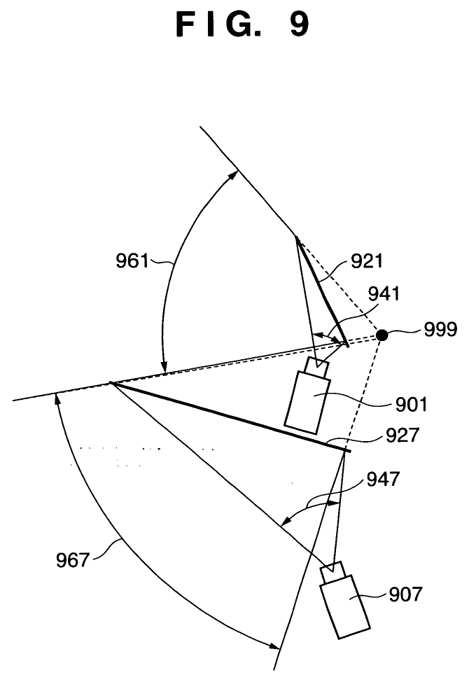

This embodiment will explain the arrangement of cameras and mirrors which can obtain a broader view than that obtained by the arrangement of the cameras and mirrors described in the first and second embodiments. FIG. 9 shows an example of that arrangement. FIG. 9 is a top view of the image sensing apparatus according to this embodiment. Hence, the vertically upward direction agrees with a direction that comes out of the plane of paper, and the vertically downward direction agrees with a direction that goes into the plane of paper. In FIG. 9, reference numerals 901 and 907 denote cameras; and 921 and 927, mirrors.

The mirrors 921 and 927 have a rectangular (or square) shape, and are arranged nearly parallel to the vertical direction. A view 941 of the camera 901 is reflected by the mirror 921 to form a view 961. Also, a view 947 of the camera 907 is reflected by the mirror 927 to form a view 967. The cameras and mirrors are laid out, so that the lens center of a virtual camera having the view 961 approximately matches that of a virtual camera having the view 967 at a point 999.

As a result, a view obtained by the arrangement shown in FIG. 9 is (view 961+view 967), and an image of a visual scene having the point 999 as the center can be sensed within this range. Each camera is not reflected in the mirror. The arrangement shown in FIG. 9 may be applied to all pairs of cameras and mirrors shown in FIGS. 3 and 8.

[Fourth Embodiment]

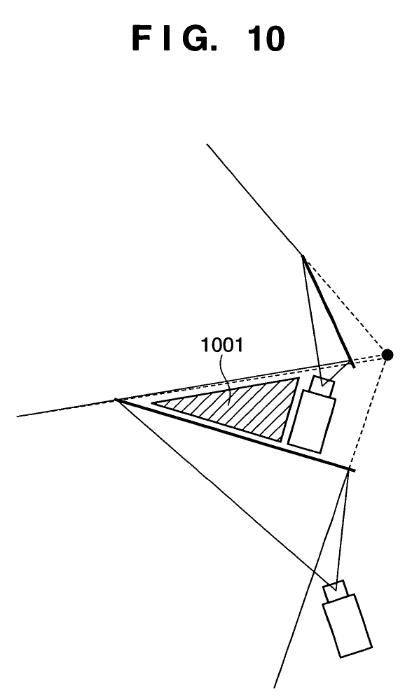

Taking the arrangement of the cameras and mirrors shown in FIG. 9 as an example, a margin portion is present. FIG. 10 shows this margin portion. In FIG. 10, a hatched portion 1001 falls outside the views of all cameras, and if an object is present there, it is never sensed by any camera. Hence, if a sound recorder is set within this margin portion 1001, a sound at that site can be recorded. In this way, by arranging various sensors on the margin portion formed by the arrangement of the cameras and mirrors, the amount of light, sound, and the like at that site can be measured without interfering within the views of all the cameras.

[Fifth Embodiment]

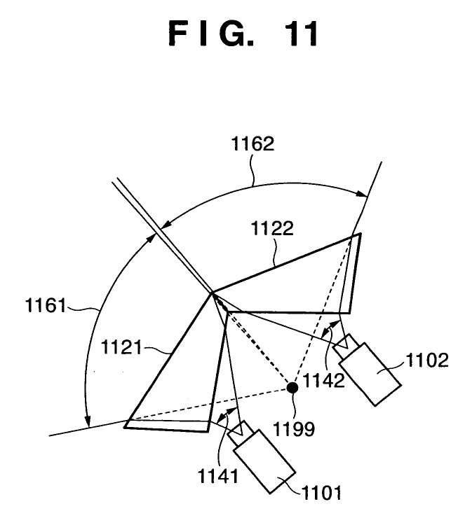

In the above embodiments, by controlling the direct views of respective cameras, a broader view is obtained. However, the present invention is not limited to this. For example, the view of each camera may be refracted using a prism or the like, and the refracted view may be used. FIG. 11 shows the arrangement of cameras and prisms in this embodiment.

By refracting a view 1141 of a camera 1101 using a prism 1121, a view 1161 can be obtained. Also, by refracting a view 1142 of a camera 1102 using a prism 1122, a view 1162 can be obtained. By laying out the cameras and prisms so that the lens center of a visual camera having the view 1161 approximately matches that of a virtual camera having the view 1162 at a point 1199, a view (view 1161+view 1162) can be obtained.

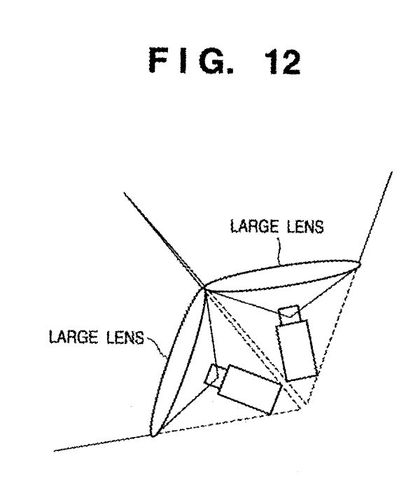

Likewise, large lenses may be used in place of the prisms, as shown in FIG. 12. The arrangement shown in FIG. 12 is substantially the same as that in FIG. 11, except that the large lenses may be used in place of the prisms.

As described above, according to the present invention, an image sensing apparatus with a small total diameter can sense a broad view range from one viewpoint at an identical time and a high resolution.

As many apparently widely different embodiments of the present invention can be made without departing from the spirit and scope thereof, it is to be understood that the invention is not limited to the specific embodiments thereof except as defined in the claims.

What is claimed is:

1. An image sensing apparatus comprising:
first image sensing unit adapted to sense a first direction;
second image sensing unit adapted to sense a second direction;
first view control unit adapted to control a view of said first image sensing unit to a first view different from that view; and
second view control unit adapted to control a view of said second image sensing unit to a second view adjacent to the first view in a horizontal plane,
wherein said first and second view control units do not share ridge lines with each other, and a lens center of virtual image sensing unit having the first view approximately matches a lens center of virtual image sensing unit having the second view.

2. The apparatus according to claim 1, wherein said second image sensing unit is arranged near a position opposing said first image sensing unit, and said second image sensing unit senses a direction opposite to the direction sensed by said first image sensing unit.

3. The apparatus according to claim 1, wherein said second image sensing unit is arranged at a position separated a predetermined distance from a position of said first image sensing unit in a direction approximately parallel to the direction sensed by said first image sensing unit, said first and second image sensing units sense that direction, and said second view control unit is arranged at a position separated the predetermined distance from a position of said first view control unit in that direction.

4. The apparatus according to claim 1, wherein said first and second view control units comprise mirrors.

5. The apparatus according to claim 1, further comprising:
image recording unit adapted to record images sensed by said first and second image sensing units;
synchronization signal generation unit adapted to output a synchronization signal, with which said first and second image sensing units operate synchronously; and
code appending unit adapted to append a code common to each predetermined timing to the images sensed by said first and second image sensing units.

6. The apparatus according to claim 5, wherein the code includes a sensing time of an image.

7. The apparatus according to claim 5, wherein the code includes a sensing position of an image.

8. The apparatus according to claim 5, further comprising:
generation unit adapted to generate an image viewed from an approximately matched viewpoint position by joining the images, which are recorded in said image recording unit and are appended with the common code, in accordance with positions and postures of said first and second image sensing units and said first and second view control units, which are measured in advance.

9. The apparatus according to claim 1, wherein said first and second image sensing units comprise cameras, which sense either a still image or a moving image.

10. A method of controlling an image sensing apparatus, comprising:
a step of sensing a first direction using first image sensing unit;
a step of sensing a second direction using second image sensing unit;
a step of controlling a view of the first image sensing unit to a first view different from that view using first view control means; and
a step of controlling a view of the second image sensing unit to a second view adjacent to the first view in a horizontal plane using second view control means,
wherein the first and second view control units do not share ridge lines with each other, and a lens center of virtual image sensing unit having the first view approximately matches a lens center of virtual image sensing unit having the second view.
